(19) United States
(12) Patent Application Publication
(10) Pub. No.: US 2024/0186642 A1
(43) Pub. Date: Jun. 6, 2024

(54) BATTERY AND METHOD OF ALLOWING FOR VOLUMETRIC EXPANSION OF BATTERY CELLS WITHIN A BATTERY

(71) Applicant: CPS Technology Holdings LLC, New York, NY (US)

(72) Inventors: Eric Lee, Antioch, IL (US); Nicholas E. Elison, Mequon, WI (US)

(21) Appl. No.: 18/552,497

(22) PCT Filed: Apr. 29, 2022
(86) PCT No.: PCT/US2022/026983

§ 371 Date: Sep. 26, 2023

Related U.S. Application Data
(60) Provisional application No. 63/182,445, filed on Apr. 30, 2021.

(51) Int. Cl. H01M 50/293; H01M 50/209; H01M 50/242; H01M 50/249; H01M 50/291

(52) U.S. Cl. CPC H01M 50/293; H01M 50/209; H01M 50/242; H01M 50/249; H01M 50/291; H01M 2220/20

(57) ABSTRACT

A battery having a first battery cell and a second battery cell with a spacer located between the first and second battery cells. The spacer comprises a polymer layer and one or more foam elements which are positioned in a substantially vertical direction on the polymer layer. The foam elements are positioned on the polymer layer to permit volumetric expansion of the battery cell. A method for allowing for volumetric expansion of battery cells within a battery. The method comprises placing a spacer between a first battery cell and a second battery cell. The spacer comprises a polymer layer and one or more foam elements positioned substantially vertically on the polymer layer so as to permit volumetric expansion of the battery cell.

### BACKGROUND

The disclosure relates generally to the field of batteries and battery systems. More specifically, the disclosure relates to a spacer for use between battery cells of a battery system.

A vehicle, for example, uses one or more battery systems. In particular, a vehicle (e.g., an electric vehicle, a hybrid vehicle) may use a lithium-ion (Li-ion) battery in place of or in addition to a more traditional lead-acid battery. As will be appreciated by those skilled in the art, hybrid electric vehicles (HEVs), also considered xEVs, combine an internal combustion engine propulsion system and a battery-powered electric propulsion system, such as 48 Volt (V) or 130V systems. In some electric vehicles, the lithium-ion battery supplies a majority of or all of the power used to propel the vehicle. Some hybrid electric vehicles may recover braking energy through a belt or crank integrated starter generator. This energy is stored in the lithium-ion battery cells. Thus, the lithium-ion are also used to store re-claimed energy while the vehicle is in use, in addition to storing a typical charge collected from another power source (e.g., an AC power source) while the car is not in use.

Lithium-ion cells swell during a typical charge/discharge cycle and/or over time through normal use. While some swelling is acceptable, too much swelling of lithium-ion cells can create stress on adjacent battery cells and/or increase the overall compression of a cell stack. Too much stress or compression can affect the performance of lithium-ion batteries and can result in less-than-optimal battery life.

As technology continues to evolve, there is a need to provide improved power sources, particularly battery systems, for such vehicles.

### SUMMARY

Summaries of various aspects are set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The disclosure relates to batteries and battery systems. More specifically, this disclosure relates to lithium-ion battery cells that may be used in vehicles as well as other energy storage/expending applications (e.g., energy storage for an electrical grid).

The disclosure relates to a battery system including a battery cell assembly disposed within an interior space of the housing between the first and second interior surfaces. The battery cell assembly includes a number of battery cells positioned in one or more battery stacks. The battery cells in each battery stack are spaced apart by a spacer, as described herein. The spacer described herein improves performance of the lithium-ion battery cells and the battery system.

In one embodiment, a battery is disclosed. The battery includes a first battery cell and a second battery cell. A spacer is present between the first and second battery cells, the spacer including a polymer layer and one or more foam elements positioned substantially vertically on the polymer layer.

In another embodiment, a method of allowing for volumetric expansion of battery cells within a battery is disclosed. The method includes placing a spacer between a first battery cell and a second battery cell, wherein the spacer includes a polymer layer and one or more foam elements positioned substantially vertically on the polymer layer.

The disclosure also relates to a method for manufacturing a battery system. The method includes positioning spacers between battery cells in a battery stack and positioning the battery stack in the battery system.

### BRIEF DESCRIPTION OF THE DRAWINGS

Various examples of embodiments of the systems, devices, and methods according to this invention will be described in detail, with reference to the following figures.

FIG. 1 is a perspective view of a vehicle (e.g., an xEV) having a battery system contributing a portion or all of the power for the vehicle, in accordance with an embodiment of the present application.

FIG. 2 is a cutaway schematic view of the vehicle of FIG. 1, in the form of a hybrid electric vehicle (HEV) having a battery system.

FIG. 3 is an isometric view of an example battery system used in FIG. 2.

FIG. 4 is an exploded view of the battery system of FIG. 3, illustrating one or more examples of arrangements of features which may be used to form the battery system.

FIG. 5 is a top view of a battery cell stack of FIG. 4 with spacers positioned between the cells.

FIG. 6 is an isometric view of a battery cell with a spacer from the battery cell stack of FIG. 5.

FIG. 7 is a front view of a battery cell with a spacer from the battery cell stack of FIG. 5.

FIG. 8 is an isometric view of the spacer of FIGS. 5-7.

FIG. 9 is a front view of the spacer of FIGS. 5-8.

FIG. 10 is a cutaway view of circle 10 of an edge of the spacer and battery cell of FIG. 9.

FIG. 11 is a top view of the spacer of FIGS. 5-8.

FIG. 12 is a detailed cross-sectional view of circle 12 of the spacer and battery cell of FIGS. 5-11.

FIG. 13 is an exploded view of a battery cell and spacer.

FIG. 14 is an isometric view of a battery cell with another form of spacer.

FIG. 15a is a top view of a battery cell stack of FIG. 4 with spacers positioned between the cells in a first pattern.

FIG. 15b is a top view of a battery cell stack of FIG. 4 with spacers positioned between the cells in a second pattern.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION OF THE DRAWINGS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The battery systems described herein may be used to provide power to various types of electric vehicles (e.g., xEVs) and other high voltage energy storage/expending applications (e.g., electrical grid power storage systems). Such battery systems may include one or more battery systems, each battery system having a housing and a number of battery cells (e.g., Lithium-ion (Li-ion) electrochemical cells) arranged within the housing to provide particular voltages and/or currents useful to power, for example, one or more components of a vehicle. As another example, battery systems in accordance with present embodiments may be incorporated with or provide power to stationary power systems (e.g., non-automotive systems).

Embodiments include physical battery system features, assembly components, manufacturing and assembling techniques, and so forth, that facilitate the manufacture of battery systems and systems in a manner that may enable a wider tolerance of battery cell dimensions, a wider degree of variability within that tolerance, and a potential reduction in size and weight of the battery systems and systems. Indeed, using the approaches described herein, it may be possible to design certain advanced battery systems (e.g., Li-ion battery systems) to have a desired form factor.

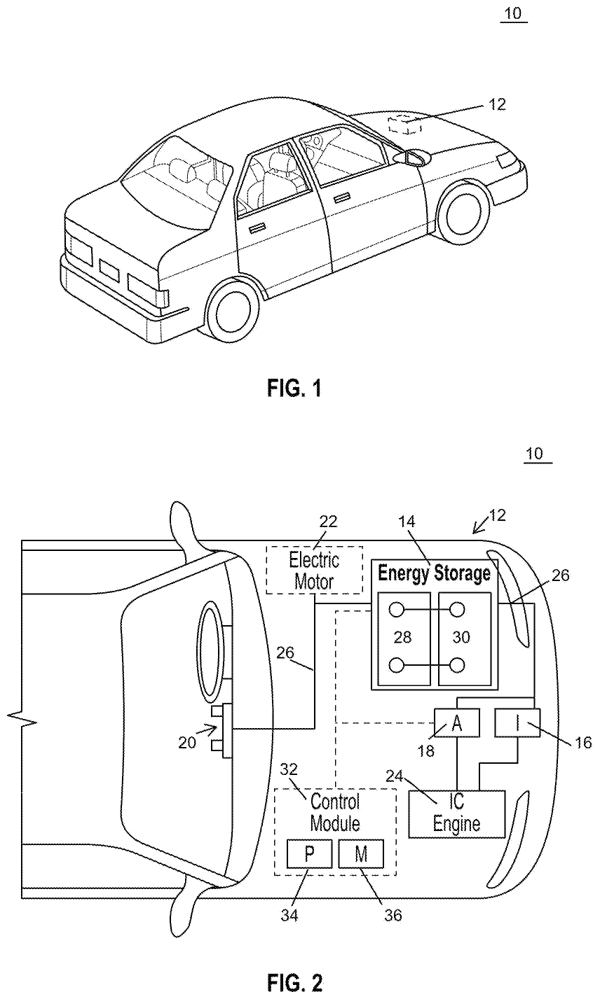

Again, the battery systems configured in accordance with embodiments may be employed in any number of energy expending systems (e.g., vehicular contexts and stationary power contexts). To facilitate discussion, constructions of the battery systems described herein are presented in the context of advanced battery systems (e.g., Li-ion battery systems) employed in vehicles (e.g., xEVs). With the foregoing in mind, FIG. 1 is a perspective view of such a vehicle 10, which may utilize a regenerative braking system. Although the following discussion in presented in relation to vehicles (e.g., electric-powered vehicles, gas-powered vehicles), the techniques described herein are adaptable to other uses of battery systems that capture/store electrical energy with a battery (e.g., commercial applications, electric power grids, generators, etc.).

It may be desirable for a battery system 12 to be largely compatible with traditional vehicle designs. For example, as illustrated, the vehicle 10 may include the battery system 12 positioned similarly to a lead-acid battery of a typical combustion-engine vehicle (e.g., under the hood of the vehicle 10). Furthermore, as will be described in more detail below, the battery system 12 may be positioned to facilitate managing temperature of the battery system 12. In some embodiments, positioning a battery system 12 under the hood of the vehicle 10 enables an air duct to channel airflow over the battery system 12 and cool the battery system 12.

A more detailed view of the battery system 12 is described in FIG. 2. As depicted, the battery system 12 includes an energy storage component 14. The energy storage component is coupled to an ignition system 16, an alternator 18, a vehicle console 20, and optionally to an electric motor 22. Generally, the energy storage component 14 may capture/store electrical energy generated in the vehicle 10 and output electrical energy to power electrical devices in the vehicle 10.

The battery system 12 may supply power to components of the vehicle's 10 electrical system, which may include radiator cooling fans, climate control systems, electric power steering systems, active suspension systems, auto park systems, electric oil pumps, electric super/turbochargers, electric water pumps, heated windscreen/defrosters, window lift motors, vanity lights, tire pressure monitoring systems, sunroof motor controls, power seats, alarm systems, infotainment systems, navigation features, lane departure warning systems, electric parking brakes, external lights, or any combination thereof. In the depicted construction, the energy storage component 14 supplies power to the vehicle console 20 and the ignition system 16, which may be used to start (e.g., crank) the internal combustion engine 24.

Additionally, the energy storage component 14 may capture electrical energy generated by the alternator 18 and/or the electric motor 22. In some implementations, the alternator 18 generates electrical energy while the internal combustion engine 24 is running. More specifically, the alternator 18 may convert the mechanical energy produced by the rotation of the internal combustion engine 24 into electrical energy. Additionally or alternatively, when the vehicle 10 includes an electric motor 22, the electric motor 22 generates electrical energy by converting mechanical energy produced by the movement of the vehicle 10 (e.g., rotation of the wheels) into electrical energy. Thus, the energy storage component 14 may capture electrical energy generated by the alternator 18 and/or the electric motor 22 during regenerative braking. As such, the alternator 18 and/or the electric motor 22 are generally referred to herein as a regenerative braking system.

To facilitate capturing and supplying electric energy, the energy storage component 14 may be electrically coupled to the vehicle's 10 electric system via a bus 26. For example, the bus 26 enables the energy storage component 14 to receive electrical energy generated by the alternator 18 and/or the electric motor 22. Additionally, the bus 26 may enable the energy storage component 14 to output electrical energy to the ignition system 16 and/or the vehicle console 20. Accordingly, when a 12 Volt (V) battery system 12 is used, the bus 26 may carry electrical power typically between 8-18 volts.

Additionally, as depicted, the energy storage component 14 includes multiple battery systems. For example, in the depicted embodiment, the energy storage component 14 includes a lithium-ion (e.g., a first) battery system 28 and a lead-acid (e.g., a second) battery system 30, which each includes one or more battery cells. In other constructions, the energy storage component 14 includes any number of battery systems. Additionally, although the lithium-ion battery system 28 and lead-acid battery system 30 are depicted adjacent to one another, they may be positioned in different areas around the vehicle 10. For example, the lead-acid battery system 30 may be positioned in or about the interior of the vehicle 10 while the lithium-ion battery system 28 may be positioned under the hood of the vehicle 10.

In some implementations, the energy storage component 14 includes multiple battery systems to utilize multiple different battery chemistries. For example, when the lithium-ion battery system 28 is used, performance of the battery system 12 may be improved since the lithium-ion battery chemistry generally has a higher coulombic efficiency and/or a higher power charge acceptance rate (e.g., higher maximum charge current or charge voltage) than the lead-acid battery chemistry. As such, the capture, storage, and/or distribution efficiency of the battery system 12 may be improved.

To facilitate controlling the capturing and storing of electrical energy, the battery system 12 additionally includes a control system 32. More specifically, the control system 32 may control operations of components in the battery system 12, such as relays (e.g., switches) within the energy storage component 14, the alternator 18, and/or the electric motor 22. The control system 32 may regulate the amount of electrical energy captured/supplied by each battery system 28 or 30 (e.g., to de-rate and re-rate the battery system 12), perform load balancing between the battery systems 28 and 30, determine a state of charge of each battery system 28 or 30, determine temperature of each battery system 28 or 30, control voltage output by the alternator 18 and/or the electric motor 22, and the like.

As shown in FIG. 2, the control system 32 includes one or more processors 34 and one or more memories 36. More specifically, the one or more processors 34 may include one or more application-specific integrated circuits (ASICs), one or more field-programmable gate arrays (FPGAs), one or more general purpose processors, or any combination thereof. Additionally, the one or more memories 36 may include volatile memory, such as random-access memory (RAM), and/or non-volatile memory, such as read-only memory (ROM), optical drives, hard disc drives, or solid-state drives. In some embodiments, the control system 32 may include portions of a vehicle control unit (VCU) and/or a separate battery control system. Furthermore, as depicted, the lithium-ion battery system 28 and the lead-acid battery system 30 are connected in parallel across their terminals. In other words, the lithium-ion battery system 28 and the lead-acid battery system 30 may be coupled in parallel to the vehicle's 10 electrical system via the bus 26.

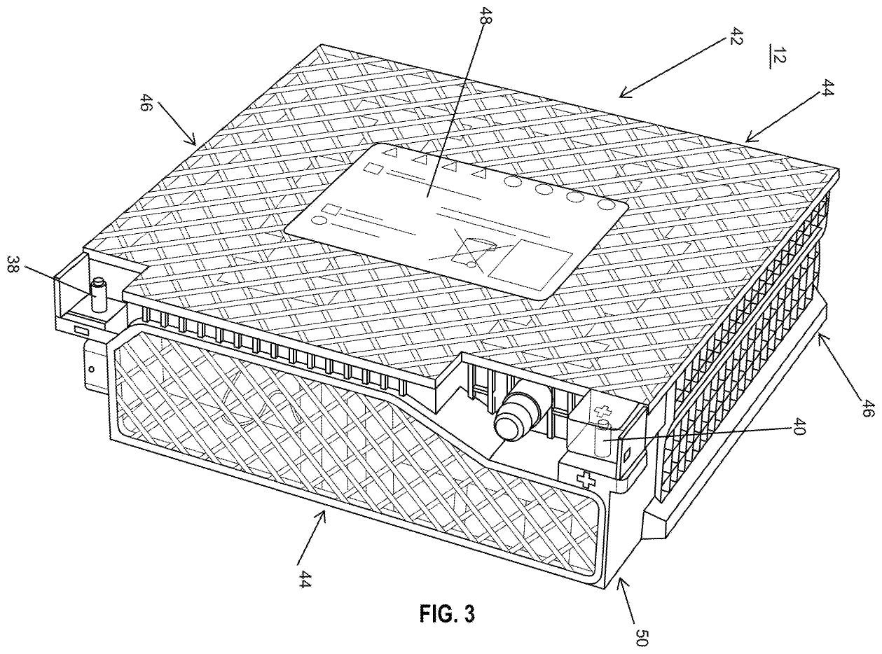

The lithium-ion battery systems 28 may have any one of a variety of different shapes, sizes, output voltages, capacities, and so forth, and this disclosure is generally intended to apply to different variations of the shapes and sizes of the systems illustrated in the figures. Keeping this in mind, FIG. 3 is a front top perspective view of one construction of the battery system 12.

The battery system 12 includes a first terminal 38 (e.g., a negative terminal) and a second terminal 40 (e.g., a positive terminal) that may be coupled to an electrical load (e.g., circuit). In other constructions, the battery system 12 has more than two terminals, to provide different voltages for different loads via connections across different terminal combinations.

FIG. 3 depicts an example construction of the battery system 12. The battery system 12 includes a housing 42 for packaging or containing a plurality of battery cells 43 and other components of the battery system. As will be described in more detail below, the housing 42 packages a plurality of prismatic battery cells 43. The housing 42 includes two end portions 44, two side portions 46, a top portion 48 (e.g., fitted with a top cover), and a bottom portion 50. FIG. 3 shows the top portion 48, one of the two end portions 44, and one of the two side portions 46. The housing 42 may be polymeric (e.g., polypropylene, acrylonitrile butadiene styrene (ABS), a polystyrene (PS), a polyimide (PI), or another suitable polymer or plastic or combination thereof), or any other suitable housing material or combination of materials.

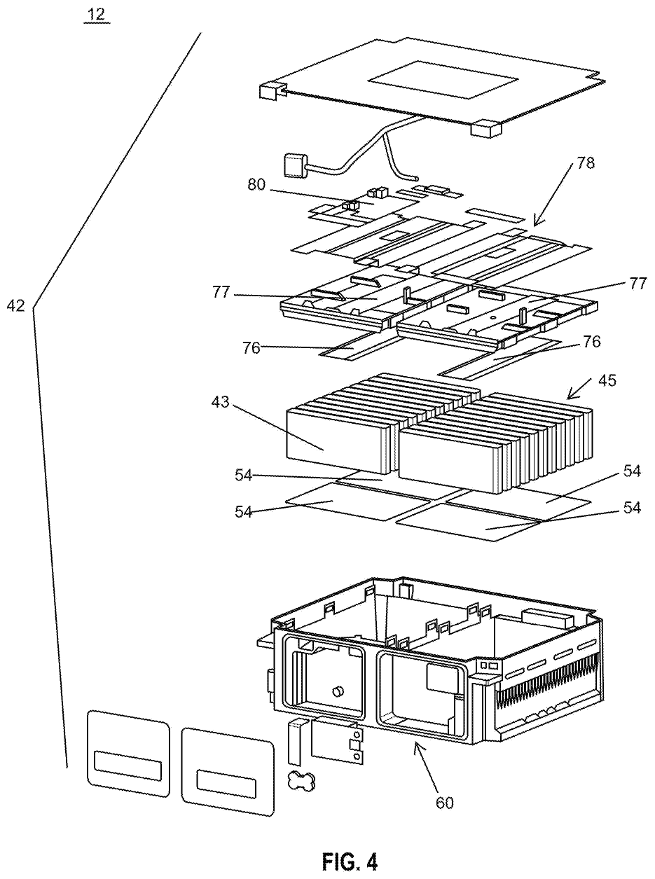

FIG. 4 illustrates an exploded perspective view of an example construction of the battery system 12 of FIG. 3, including the housing 42 that is sized to facilitate placement of a plurality of battery cells 43 in a desired manner. The battery system 12 may include another number of battery cells 43, depending on the voltage and/or capacity requirements of the battery system 12, as well as the individual voltage and capacity of each battery cell 43 and the manner in which they are coupled. Accordingly, other numbers and/or arrangement of battery cells 43 may be used depending on the desired power of the battery system 12 and/or the desired dimensions (e.g., length, width, and/or height) of the battery system 12.

While any single type of battery cell 43 may be utilized, the battery cells 43 used in the battery system 12 all have the same general shape (e.g., prismatic, cylindrical, pouch, or any other), the same electrochemistry (e.g., electrode active materials, electrolytes, additives), the same general dimensions (e.g., to within manufacturing tolerances), and other similar design features (e.g., electrical isolation). In the depicted construction, the battery system 12 includes a number of battery cells 43 sufficient to enable the battery system 12 to provide a 48 V output, though the battery system 12 may output other voltages (e.g., 12 V) using different numbers and/or connections of battery cells 43. In various constructions, the battery cells 43 may comprise four groups of six battery cells 43.

As shown in FIG. 4, the battery cells 43, before introduction into the system housing 42, are arranged in a cell stack 45. It should be noted that the battery cells 43 may be positioned in any suitable arrangement. For example, while four cell stacks 45 may be utilized, in other constructions, the battery cells 43 may be arranged in one, two, three, or more cell stacks 45. Further, the one or more cell stacks 45 may be oriented vertically (e.g., in a columnar arrangement) or horizontally (e.g., in a row arrangement).

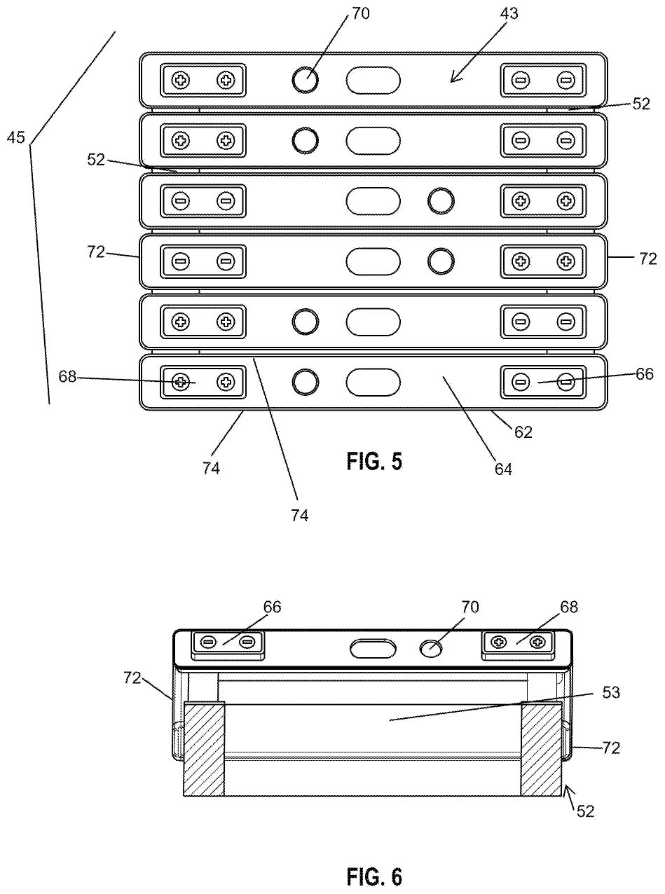

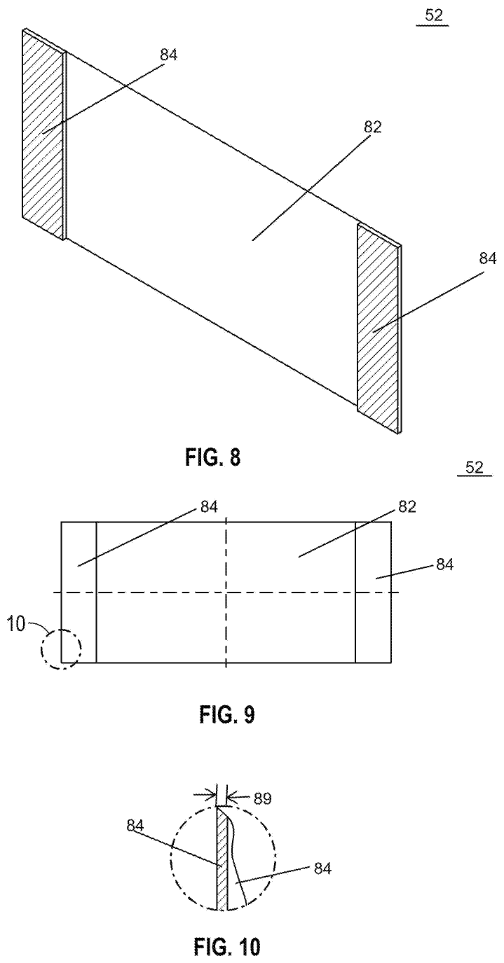

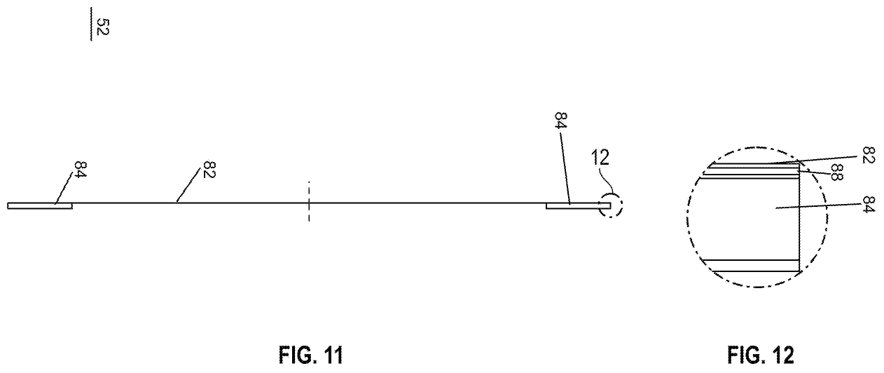

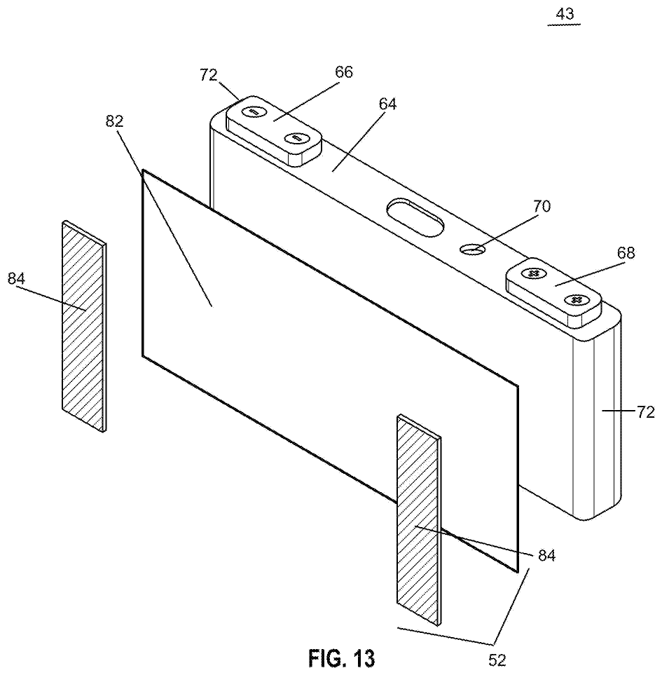

A spacer 52, such as depicted in FIGS. 5-16, is positioned between each battery cell 43 of the cell stack 45 to separate the battery cells 43 from one another. In various constructions, an insulating or electrically isolating material (e.g., an additional type of spacer 52) or film 53 is disposed around the conductive surfaces of the battery cells. The cell isolation film 53 may further require use of an adhesive. Additionally, a heat-blocking layer or reflective layer may be included with the spacer 52 between the two battery cells. In some examples, a heat-sensitive or thermally sacrificial layer (not shown) may also be included with the spacer 52 between the two battery cells 43. The example heat-sensitive layer may be to prevent a thermal event or thermal runaway in the cell stack 45 by limiting or preventing a thermal runaway of a single battery cell 43 from transferring to other battery cells 43 in the cell stack 45.

The cell stack 45 of battery cells 43 is inserted into an opening of the housing 42. The housing 42 is large enough to accommodate the desired number of battery cells 43 and other components. In the depicted construction, the housing 42 is divided into four quadrants 54. While four quadrants 54 are depicted, various alternative housing arrangements should be understood as within the scope of this disclosure. The housing 42 also includes vehicle connection components, such as, but not limited to, positive terminals 40 and negative terminals 38 and a power connector. In various constructions, the negative terminals 38 and positive terminals 40 may each be comprised of a bus bar 56 and a stud 58. As shown in FIG. 4, the battery cells 43 are provided on top of the base 60 using a layer of epoxy. The layer of epoxy reflects the four-quadrant 54 division of the housing.

The battery cells 43 described herein are prismatic battery cells 43, where a prismatic battery cell 43, as defined herein, includes a prismatic casing 62 that is generally rectangular in shape. In contrast to pouch cells, the prismatic casing 62 is formed from a relatively inflexible, hard (e.g., metallic) material. However, it should be noted that certain constructions may incorporate pouch cells in addition to or in lieu of prismatic battery cells 43. In accordance with present constructions, each prismatic battery cell 43 includes a prismatic cell casing 62 which includes a top casing portion 64 where a set of cell terminals (e.g., positive cell terminals 66 and negative cell terminals 68) are located. One or more cell vents 70 are also located on the top casing portion 64. The prismatic cell casing 62 also includes a bottom casing portion 71 positioned opposite the top casing portion. First and second sides 72 may be straight or rounded, and extend between the top casing portions 64 and bottom casing portions 71 in respective positions corresponding to the positive cell terminals 66 and negative cell terminals 68. First and second faces 74, which may be flat (as shown) or rounded, couple the first and second sides 71 at opposing ends of each battery cell 43.

As described above, the battery cell stacks 45 are provided into the housing 42, as shown in FIG. 4, atop a layer of epoxy as well as the base 60 of the housing 42. Connecting materials are then provided atop the cells 43 in order to transmit the power out of the terminals 66, 68. In the illustrated example construction, a sheet (e.g., a metal sheet) 76 is provided between the cell stacks 45 and one or more carriers 77 (e.g., a “b-carrier”). In some examples, the carrier 77 may hold electrical connection components 78 as well as one or more process control boards (PCBs) 80. These electrical connection components 78 may include, but are not limited to, a flexible printed circuit (FPC) for facilitating the electrical connections, a battery management unit (BMU), wire harnesses, one or more bus bars, shunts, relays, fuses, vehicle connector plugs, terminals, and/or covers.

FIG. 5 depicts an example construction of the battery cell stack 45 with a plurality of spacers 52 positioned between pairs of cells 43 (e.g., a first cell, a second cell) of the cell stack 45. In some examples, one or more cells 43 of a pair of cells 43 may also be included in one or more adjacent pairs of cells 43. Alternatively, a cell 43 of the pair of cells 43 may be positioned on an end of the cell stack 45 and is only included in a single pair of cells 43. As shown in FIG. 5, one spacer 52 is positioned between each pair of cells 43 of the cell stack 45.

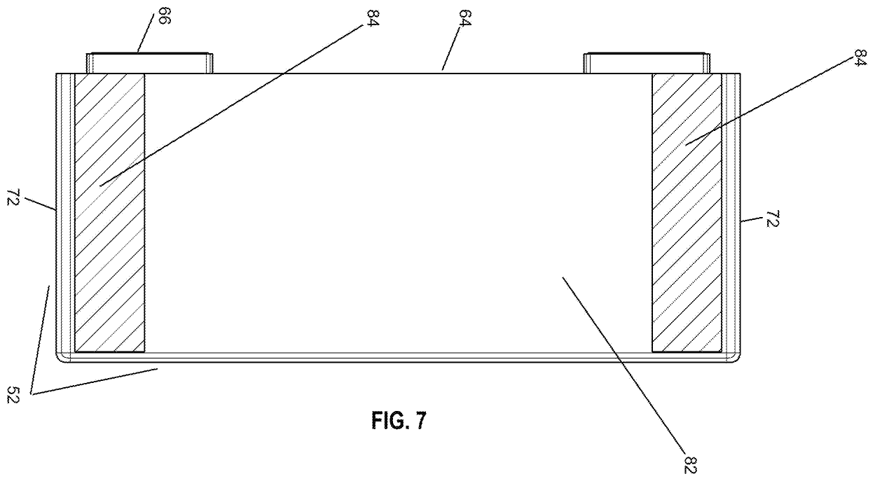

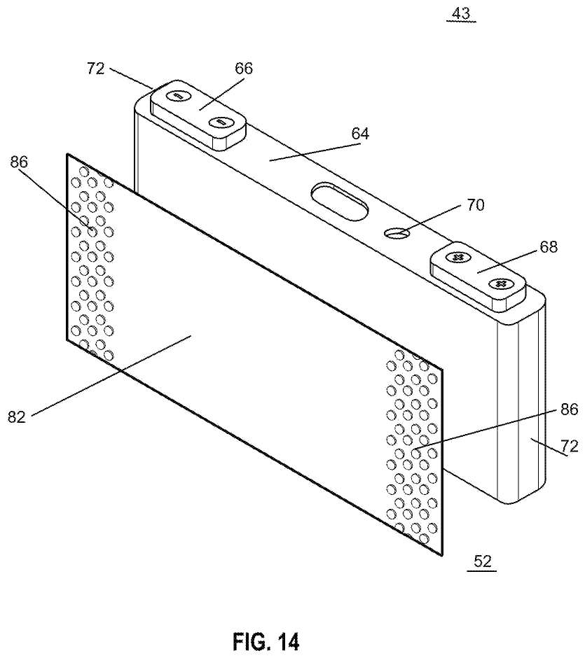

FIGS. 7-15 depict alternative views of an example construction of the spacers 52. Each spacer 52 includes a thin layer of non-conductive polymer (e.g., a polymer layer 82) and two vertical elements of dense foam (e.g., foam strips 84 are shown in FIGS. 5-16) attached to the polymer layer 82 or film 53. The example dense foam is a closed cell foam and is hydrophobic so that the foam does not absorb or hold water. In some examples, the vertical elements of dense foam are in a different shape (e.g., dots or other shaped pieces) than a foam strip 84. For example, as shown in FIG. 14, the foam elements may each comprise a plurality of foam pieces 86. While the foam elements as depicted take the form of foam strips 84 and foam pieces 86, the foam elements may take any other form, shape, or combination of shapes, as desired. The two foam strips 84 are attached to the same side (e.g., face) of the polymer layer 82. The foam strips 84 are positioned vertically along opposite edges (e.g., left and right edges) of the polymer layer 82. Thus, the foam strips 84 are adjacent left and right edges of the cells on one side or face of the spacer 52. The foam strips 84 may also be offset from the left and right edges of the polymer layer 82 on one side or face of the spacer 52. The example foam strips 84 of each spacer 52 create a gap (e.g., spacing) between each pair of cells 43. The foam strips 84 may have any suitable width (e.g., a width corresponding to a width of a portion of the battery that does not swell) and a thickness. In some examples, the width may be between 5 and 25 mm. In one particular example, the foam strips 84 have a thickness between 1.24 mm and 1.74 mm and a width between 14.5 mm and 15.5 mm. In this particular example, the spacers 52 have a height of 59.7 mm to 60.3 mm and a width of 139.5 mm to 140.5 mm. It is anticipated that both the width and thickness of the foam strips 84 may be of any appropriate value and that these values may depend upon can design, construction materials, particular battery cell 43 chemistry, type and quantity of electrolyte, and any other factors, as appropriate. The foam strips 84 may extend along any portion of the height of the polymer layer 82. Preferably, the foam strips 84 extend along the entire height of the polymer layer 82.

The position of the foam strips 84 on the vertical edges of the polymer layer 82 allows for expansion (e.g., swelling) of the battery cells 43 in the middle (e.g., adjacent a central vertical axis) of the battery cells 43. It is advantageous to place the foam strips 84 adjacent the left and right edges of the battery cell 43 because cell swelling typically occurs in the middle area of the battery cell 43, which is where the electrode layers interact with the electrolyte. Placement of the foam strips 84 in locations offset from the left and right edges of the battery cell 43 is also possible. Additionally, current collector tabs (not shown) are typically positioned near the left and right edges of the battery cell 43 and there is little or no electrical-chemical reaction in this area. Because there is little or no electrical-chemical reaction near the left and right edges of the battery cells 43, there is also no swelling in these areas. Therefore, positioning the foam strips 84 near the edges of the battery cells 43 allows for swelling in optimal locations of the battery cells 43 and enables the battery cells 43 to achieve optimal performance and usability over their life. It should be appreciated that any of the foam strips 84 may be placed in other appropriate locations to allow for swelling in optimal locations of the battery cells 43.

In alternative constructions, die-cut pieces of solid material may be used instead of foam elements. In some alternative constructions, a separate part with protruding finger-like features may be used to provide appropriate cell spacing. For example, ribs on the battery housing or a comb-like part that provides spacing for multiple cells in a grouping may be an alternative way of positioning spacers adjacent the edges of the cells to allow for swelling in the middle of the cells.

In some examples, the foam strips 84 are aligned with the edges of the polymer layer 82. As shown in FIG. 10 in a detailed partial view of the example construction, the foam strips 84 are spaced no more than a width 89 of 1.5 mm away from the edges of the polymer layer 82. Alternatively, the foam strips 84 may be spaced further from the edges of the polymer strips 82, but still spaced sufficiently far apart from one another to allow for swelling at the center of the battery cells 43. Additionally, the foam strips 84 preferably do not extend past an edge of the battery cell 43.

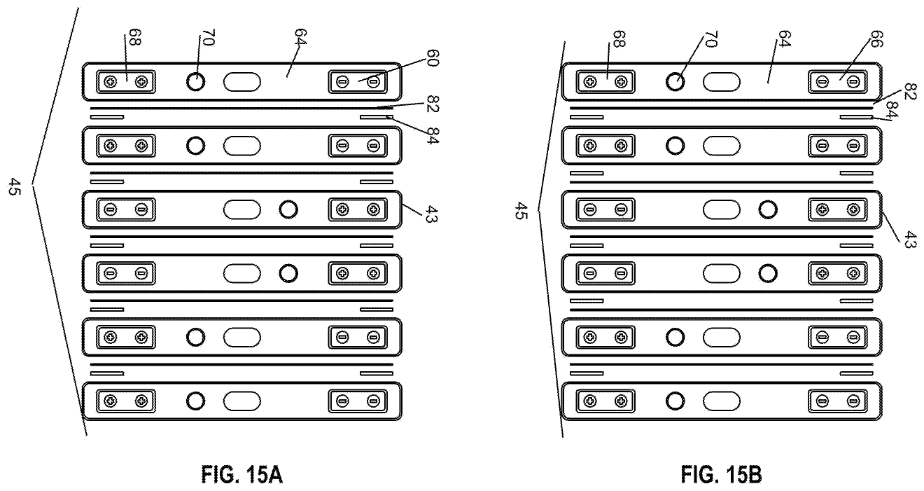

FIG. 12 is a partial cross-section depicting the layers of the spacer 52 where the foam strips 84 are attached to the polymer layer 82. A layer of adhesive tape 88 bonds the foam strips 84 to the polymer layer 82. Additional layers of adhesive join the adjacent pair of cells to either side of the spacer 52. In the example construction, a first adhesive type is placed on either side of the polymer layer 82. On one side of the polymer layer 82, the first adhesive type may be applied only in the area where the foam strips 84 will be coupled. On the other side of the polymer layer 82, the first adhesive type may be applied to the entire face of the polymer layer 82 to more securely attach the spacer 52 to one of the pair of battery cells 43. A second type of adhesive is applied to the side of the foam strip 84 that is coupled to the other of the pair of battery cells 43. The second type of adhesive may be stronger to offset the reduced contact area between the adhesive on the foam strips 84 and the other of the pair of battery cells 43. As seen in FIGS. 15a,b, when the cell stack 45 is formed, the sides of the respective polymer layer 82 to which the foam strips 84 are attached may all face in the same direction (as shown in FIG. 16a) or may face in alternating directions (as shown in FIG. 16b). Any other orientation, such as a different pattern from those previously described or no pattern, is anticipated.

Swelling is an inherent characteristic of lithium-ion battery cells 43. In particular, battery cells 43 using a nickel manganese cobalt oxide (NMC) graphite chemistry are more sensitive to swelling than cells using lithium-titanate (LTO) chemistry. A certain amount of swelling is acceptable. If lithium-ion battery cells 43 are fully constrained from swelling, the battery cells 43 will not have optimal life and performance. If the battery cells 43 are completely unconstrained, the battery cells 43 may fail due to premature rupture of the cell casing 62. Swelling of the middle portion of a prismatic cell, such as the battery cells 43 depicted in the example construction, is a natural occurrence during cell charging and discharging. Allowing the battery cells 43 to swell in the middle, as described in conjunction with the example construction, improves performance of the battery cells 43.

Typical spacers 52 between battery cells 43 use an adhesive tape layer and a thin layer of non-conducting material to avoid electrical shorting between cells. In some of these constructions, there is not sufficient space to accommodate the natural swelling of the battery cells 43. Additionally, using only spacer materials, such as foam, is not ideal because the foam or other spacer materials can absorb moisture, which may create an electrical path between cells. The example construction described herein uses both a non-conducting thin material (e.g., polymer layer 82) as well as foam strips 84. The foam strips 84 may be closed cell, hydrophobic foam strips 84 so that the foam strips 84 do not absorb or hold liquid. This example construction provides the benefits of both electrical insulation and physical spacing.

Additionally, the example construction is advantageous because it reduces the number of parts in the battery pack assembly and simplifies the assembly process. The two components of the spacer 52 (i.e., the foam strips 84 and polymer layer 82) are formed as one part. Forming the spacers 52 in this manner allows the spacers 52 to be spooled onto rolls at the manufacturer. The rolls of spacers 52 are easier to implement in the manufacturing process than the previously used individual spacers. In some examples, the spacers 52 may be cut to a desired size from the roll of spacers 52 using a blade or die that is specifically designed or shaped to cut through the form spacer 52 but not the backing. Additionally, because the spacers 52 have adhesive on both faces, cells 43 can easily be grouped or coupled together, which optimizes the battery pack assembly process. The grouping of battery cells 43 in this manner reduces manufacturing time because only a few groupings of battery cells 43 are handled for each battery system 12 rather than a larger number of individual battery cells 43.

One or more of the disclosed embodiments, alone or in combination, may provide one or more technical effects including the manufacture of battery systems 12 having battery cells 43 (e.g., prismatic battery cells 43). The disclosed designs enable the use of stacks of battery cells 43 that may be placed within a housing 42 of the battery system 12 and that may be maintained below a maximum operating temperature using a heat sink. Accordingly, the disclosed battery system 12 designs may offer improved flexibility and performance compared to other battery system designs. The technical effects and technical problems in the specification are exemplary and are not limiting. It should be noted that the embodiments described in the specification may have other technical effects and can solve other technical problems.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only, and not limiting. Although only a few embodiments have been described in detail in this disclosure, those skilled in the art who review this disclosure will readily appreciate that many various alternatives, modifications, variations, improvements and/or substantial equivalents, whether known or that are or may be presently foreseen, are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes, and omissions may be made in the design, operating conditions, and arrangement of the various examples of embodiments without departing from the spirit or scope of the present inventions. Therefore, the invention is intended to embrace all known or earlier developed alternatives, modifications, variations, improvements and/or substantial equivalents.

The technical effects and technical problems in the specification are exemplary and are not limiting. It should be noted that the embodiments described in the specification may have other technical effects and can solve other technical problems.

1. A battery comprising:
a first battery cell;
a second battery cell; and
a spacer between the first and second battery cells, the spacer including a polymer layer and one or more foam elements positioned substantially vertically on the polymer layer.

2. The battery of claim 1 further comprising an adhesive coupling the spacer to one of the battery cells.

3. The battery of claim 1, further comprising a second adhesive coupling the spacer to the other of the battery cells.

4. The battery of claim 1, wherein the foam elements are attached to the polymer layer via a third adhesive.

5. The battery of claim 1, wherein the polymer layer comprises a non-conductive material.

6. The battery of claim 1, wherein the foam elements comprise closed cell, hydrophobic foam elements.

7. The battery of claim 1, wherein the one or more foam elements comprise foam strips.

8. The battery of claim 1, wherein the one or more foam elements comprise a plurality of foam pieces.

9. The battery of claim 1, wherein the polymer layer comprises substantially the same dimensions as the first battery cell, the second battery cell, or both the first battery cell and the second battery cell.

10. The battery of claim 1, wherein the one or more foam elements are positioned on the polymer layer so as to be in substantial alignment with outer edges of the polymer layer.

11. The battery of claim 1, wherein the one or more foam elements are positioned on the polymer layer so as to be offset from outer edges of the polymer layer.

12. The battery of claim 7, wherein the foam strips comprise a height extending from a bottom of the polymer layer to a top of the polymer layer.

13. The battery of claim 1, wherein the one or more foam elements are positioned on the polymer layer so as to allow volumetric expansion of one or more of the first and second battery cells in a negative space formed between the one or more foam elements.

14. A method of allowing for volumetric expansion of battery cells within a battery, the method comprising:
placing a spacer between a first battery cell and a second battery cell, wherein the spacer includes a polymer layer and one or more foam elements positioned substantially vertically on the polymer layer.

15. The method of claim 14, further comprising coupling the spacer to one of the battery cells via an adhesive.

16. The method of claim 15, further comprising coupling the spacer to the other of the battery cells via a second adhesive.

17. The method of claim 16, further comprising affixing the one or more foam elements to the polymer layer via a third adhesive.

18. (canceled)

19. (canceled)

20. (canceled)

21. The method of claim 14, further comprising positioning the foam elements on the polymer layer so as to be in substantial alignment with outer edges of the polymer layer.

22. The method of claim 14, further comprising positioning the foam elements on the polymer layer so as to be offset from outer edges of the polymer layer.

23. (canceled)

24. The method of claim 14, further comprising positioning the foam elements on the polymer layer so as to allow the volumetric expansion of one or more of the first and second battery cells in a negative space formed between the one or more foam elements.
